(19) United States
(12) Patent Application Publication
(10) Pub. No.: US 2025/0041765 A1
(43) Pub. Date: Feb. 6, 2025

(54) GAS-LIQUID SEPARATION DEVICE WITH A ZONE FOR GUIDING THE LIQUID AT THE OUTLET END, IN PARTICULAR FOR A THREE-PHASE FLUIDISED BED REACTOR

(71) Applicant: IFP Energies nouvelles, Rueil-Malmaison Cedex (FR)

(72) Inventors: Benjamin AMBLARD, Rueil-Malmaison Cedex (FR); Joao MARQUES, Rueil-Malmaison Cedex (FR); Vanessa VINCENT-GENOD, Rueil-Malmaison Cedex (FR); Driss AIT-MHAND, Rueil-Malmaison (FR); Jean-François LE COZ, Rueil-Malmaison (FR); Pierre BALZ, Rueil-Malmaison (FR); Rim BRAHEM, Rueil-Malmaison (FR)

(73) Assignee: IFP Energies nouvelles, Rueil-Malmaison Cedex (FR)

(21) Appl. No.: 18/722,353

(22) PCT Filed: Dec. 9, 2022
(86) PCT No.: PCT/EP2022/085197

§ 371 Date: Jun. 20, 2024

(30) Foreign Application Priority Data
Dec. 20, 2021 (FR) 2113963

(51) Int. Cl. B01D 19/00; C10G 49/16

(52) U.S. Cl. CPC B01D 19/0042; C10G 49/16; C10G 2300/1037; C10G 2300/4012

(57) ABSTRACT

The invention relates to a gas-liquid separation device, notably for being installed in the recycle zone of three-phase fluidized reactors. The gas-liquid separation device comprises several separation elements each having an inlet pipe (70) and a succession of at least two bends (71, 72), a first bend (71) situated in the plane (zy), the axis of the first bend (71) forming an angle of orientation α with respect to the vertical z-axis of between 45° and 315°, and a second bend (72) forming a second angle of orientation p with the first bend (71) of between 1° and 135°. The two first successive bends (71, 72) are separated by a distance D1 of between D/2 and 4D, D being the diameter of the inlet pipe (70). Each separation element comprises a liquid-guiding device (73) positioned at the outlet end of the last bend (72), and with an open section.

### TECHNICAL FIELD

The invention consists in improving the design of gas-liquid separators used notably in an H-Oil™ process, in order to obtain better gas-liquid separation in the upper zone of the reactor, which is often referred to as the liquid recycling zone or, more simply, the recycle zone.

The H-Oil™ process is a process for the hydroconversion of heavy hydrocarbon cuts, of the residue or vacuum gas oil type, which therefore brings together the liquid hydrocarbon phase, the hydrogen gas phase dispersed in the form of bubbles, and the catalyst itself dispersed in the form of solid particles with a particle size typically of between 0.2 and 2 millimeters. The H-Oil™ process is therefore a three-phase fluidized process which uses a special-purpose reactor. This reactor is equipped with a gas-liquid separation device situated in the upper part of the reactor so as to allow the recycling of the liquid which is returned after separation in the reaction zone of the reactor. One of the significant features of reactors of the H-Oil™ type is their high liquid recycle rate defined as being the ratio of the flow rate of recycled liquid to the flow rate of incoming liquid feedstock, and which generally lies in the range from 1 to 10.

The present invention can be defined as being an improved gas-liquid separation device, notably for reactors of the H-Oil™ type, which allows the majority of the liquid to be reintroduced without gas into the reaction zone, with the gas (and also some of the liquid) being removed out of the reactor, and which limits the turbulence at the gas-liquid interface and the foaming effects.

However, the gas-liquid separation device can be used in other applications.

### PRIOR ART

Patent application U.S. Pat. No. 4,886,644 is known and describes the concept of “spiral risers” (or “cyclone separator”) relating to the gas-liquid separation in the H-Oil™ process by a number of turns of the spiral and an angle with respect to the horizontal.

The “recycle cup” described in that patent application corresponds to the upper part of the reactor which, after separation of the gas and the liquid, allows the liquid to return to the reaction zone of the reactor and the gas to be removed by a dedicated pipe.

In the remainder of the text, the expression upper liquid recycling zone or, more simply, recycle zone will be used.

Document U.S. Pat. No. 4,886,644 also describes an arrangement of the upper recycle zone with the gas-liquid removal pipe at the top of the reactor.

FIG. 1 is a representative diagram showing the key elements of an H-Oil™ reactor according to the prior art, such as the one in patent application U.S. Pat. No. 4,886,644. This figure shows the reaction zone 22 corresponding to the three-phase fluidized bed containing the catalyst, the zone situated above the catalytic zone and referred to as the gas-liquid separation zone 39 which allows the liquid to be recycled to the lower part of the reactor by means of the recirculation pump 20. The gas-liquid separation devices are represented by the separation elements 27 and 28, some elements having their lower end situated in the gas-liquid separation zone 39, and other elements having their lower end situated on the surface of the “recycle cup” 30.

The three-phase fluidized reactor 10 is specifically designed with suitable materials which allow it to treat reactive liquids, liquid/solid “slurries” (that is to say suspensions, i.e. liquids containing fine solid particles dispersed within them), solids and gases at high temperature and high pressure with a preferred application in the treatment of liquid hydrocarbon cuts with hydrogen at high temperature and high pressure, that is to say at an absolute pressure of between 2 MPa and 35 MPa, preferably between 5 MPa and 25 MPa, and more preferably between 6 MPa and 20 MPa, and at a temperature of between 300° C. and 550° C., preferably of between 350° C. and 500° C., and more preferably of between 370° C. and 460° C., the favored temperature range lying between 380° C. and 440° C.

The H-Oil™ type three-phase fluidized reactor 10 is designed with a suitable inlet pipe 12 for injecting a heavy hydrocarbon feedstock 11 and a gas 13 containing hydrogen. The outlet pipes are positioned in the upper part of the reactor 10. The outlet pipe 40 is designed to draw off vapors which may contain a certain quantity of liquid, and, as an option, the pipe 24 allows mainly liquid to be drawn off. The reactor also contains a system allowing catalyst particles to be introduced and drawn off, this system corresponding schematically to the pipe 15 for introducing fresh catalyst 16, and the pipe 17 for drawing off the spent catalyst 14.

The heavy hydrocarbon feedstock is introduced through the pipe 11, while the gas containing hydrogen is introduced through the pipe 13. The feedstock and gaseous hydrogen mixture is then introduced into the reactor 10 through the pipe 12 into the lower part of the reactor.

The incoming fluids pass through a plate 18 containing suitable distributors.

In this diagram, distributors of the “bubble cap” type 19 are shown, but it should be appreciated that any distributor known to those skilled in the art which allows the fluids coming from the pipe 12 to be distributed over the entire surface of the reactor 10, and as evenly as possible, can be used.

The gas-liquid mixture flows upward and the particles of catalyst are entrained in an ebullating bed movement by the gas flow and the liquid flow induced by the recirculation pump 20 which may be internal or external to the reactor 10.

The upflow of liquid delivered by the pump 20 is enough for the volume of the catalyst bed in the reaction zone or catalytic bed 22 to expand by at least 10%, preferably from 20 to 100%, with respect to the static volume (which is to say the volume at rest) of the catalyst bed, thus allowing gas and liquid to flow through the reactor 10, as shown by the direction arrows 21.

Because of the equilibrium between the friction forces generated by the upflow of the liquid and of the gas, and the forces of gravity directed downward, the bed of catalyst particles reaches an upper level of expansion while the liquid and the gas, which are lighter, continue to head toward the top of the reactor 10, beyond this solid level. In the diagram, the level of maximum expansion of the catalyst corresponds to the interface 23. Below this interface 23 is the catalytic reaction zone 22 which therefore extends from the plate 18 to the level 23 and which comprises the catalyst.

Above the interface 23 is a zone 39 containing only gas and liquid. The particles of catalyst in the catalytic reaction zone 22 move randomly in the fluidized state, which is why the catalytic reaction zone 22 is qualified as a three-phase fluidized zone.

The zone 29 containing a low concentration of catalyst above the level of the interface 23 is filled with liquid and entrained gas. The gas is separated from the liquid in the upper part of the reactor referred to as the “recycle zone” 39 so as to collect and recycle the majority of the liquid through the central outlet duct 25 at the bottom of the recycle cup 30. The shape of the recycle cup 30 (as a funnel) allows the liquid to be collected after the separation between the gas and the liquid and to be conveyed to the central outlet duct 25. It is important for the liquid recycled through the central outlet duct 25 to contain as little gas as possible, or even no gas at all, so as to avoid the phenomenon of cavitation in the pump 20.

The liquid products that remain after the gas-liquid separation can be drawn off through the pipe 24. The pipe 40 is used for drawing off the gas.

The widened part at the upper end of the pipe 25 forms the liquid recycling zone. A plurality of vertically oriented separation elements 27 and 28 create the connection between the gas-liquid zone 29 and the recycle zone 39.

The gas-liquid mixture flows upward through the pipes of the separation elements 27 and 28. Some of the separated liquid is then directed toward the recirculation pump 20 in the direction of the arrow 31 through the central outlet duct 25 and is therefore recycled to the lower part of the reactor 10 below the plate 18.

The gas separated from the liquid flows toward the upper part of the reactor 10 and is drawn off by the upper pipe 40. The drawn-off gas 40a is then treated in a conventional way to recover as much hydrogen as possible so that the latter is recycled to the reactor through the pipe 13.

Patent application US 2019/270941 is also known and relates to an improved gas-liquid separation device for an H-Oil™ type three-phase fluidized reactor. This gas-liquid separation device ends in a succession of two bends so as to improve the separation of the liquid phase and of the gas phase, as in FIGS. 2 and 3.

FIG. 2 is a more exact diagram of the recycle zone 39 of application US2019/270941 in a reactor such as the one in FIG. 1.

FIG. 2 shows the liquid recycling zone which ends in a central outlet duct 25 which, after gas-liquid separation, returns the liquid to the lower part of the reactor via the recirculation pump. The gas-liquid separation elements 27 and 28 are installed along the conical surface 30 of the recycle zone. The gas-liquid mixture is admitted via the inlet pipes 70. Gas-liquid separation takes place in the separation devices 55. Each separation device 55 therefore consists in the tubular inlet element 70 for admitting the gas-liquid mixture, ending in the succession of two bends situated in two distinct planes, as illustrated in FIG. 3:
the first plane denoted (yz) is perpendicular to the x-axis,
the second plane denoted (xy) is perpendicular to the z-axis.

There is no elevation in the vertical direction at the transition between the two successive bends. The vertical measurement (along the z-axis) of the first bend and the vertical measurement (along the z-axis) of the second bend are substantially the same. “Substantially” is understood to mean a vertical offset that does not exceed the value D of the diameter of the gas-liquid mixture inlet pipe 70.

The liquid flowing after leaving the separation elements along the conical wall 30 is collected by the central outlet duct 25, and the gas is removed by the outlet of the second bend of each separation element 27 and 28. The gas therefore occupies the upper zone 39v of the separation zone 39 situated above the gas-liquid interface 24 and leaves the reactor via the outlet pipe 67.

The gas and the liquid flow upward as shown by the direction arrow 41 in FIG. 2 and are introduced through the inlet pipes 70 where they experience a direction change of around 90° in each instance in the first bend and in the second bend terminating the separation elements 27 and 28.

The gas-liquid interface level 24 separates the upper part 39v which predominantly contains the separated gas from the lower part 39L which predominantly contains the recycled liquid. The various separated liquids 45 emanating from the second bend of the separation elements 27 and 28 flow downward via the conical wall 30 and are collected by the central outlet duct 25 to be picked up by the recirculation pump (not shown).

The majority of the liquid 31 is therefore recycled to the recirculation pump through the central outlet duct 25. The gas and a minority of liquid 67 are drawn off through the pipe 40. The pipe 40 generally has slots 65 at its lower end which make it possible to fix the height of the liquid-gas interface 24.

FIG. 3 shows the geometry of a gas-liquid separation device according to application US 2019/270941 and shows the key geometric dimensions for dimensioning this device.

The diameter of the inlet pipe 70 of each separation element is generally between 0.02 m and 0.5 m, preferably between 0.05 m and 0.4 m, and preferably between 0.1 m and 0.3 m.

The surface velocity of upflow liquid represented by the direction arrow 41 in FIG. 1 is generally between 0.1 m/s and 20 m/s, preferably between 0.2 m/s and 15 m/s, and preferably between 0.3 m/s and 10 m/s.

The first bend situated in the plane (yz) has its orientation defined by its angle α. The value of the angle α is between 45° and 315°, preferably between 60° and 300°, and preferably between 80° and 200°.

The second bend situated in the plane (xy) has its orientation defined by its angle β. The value of the angle β is between 0° and 135°, preferably between 10° and 110°, and preferably between 30° and 100°.

The height H1 between the gas-liquid interface 24 and the second bend in the plane (xy) lies between D and 10D, and preferably between 2D and 5D, D being the diameter of the pipe 70.

The distance D1 separating the two successive bends is between D/2 and 4D, and preferably between D/2 and 2D, D being the diameter of the pipe 70.

Although the separation device in FIGS. 2 and 3 has numerous advantages, it generates turbulence and can also produce foams that are to be avoided.

The present invention thus consists in limiting the turbulence generated by the gas-liquid separation device and in minimizing the generation of foam. This thus minimizes the risk of entrainment of gas bubbles by the liquid which is recirculated to the pump in order to be reintroduced into the reactor, these bubbles being liable to generate cavitation in the pump, which could also damage the pump and limit its service life.

To do this, the invention relates to a gas-liquid separation device, notably for being installed in the recycle zone of a three-phase fluidized reactor used in a process for the hydroconversion of heavy hydrocarbon cuts in the presence of hydrogen under high pressure, the recycle zone being made up of the upper hemisphere of the reactor and delimited in its lower part by a surface configured to allow the separated liquid to return to the catalytic zone. The gas-liquid separation device according to the invention comprises a plurality of separation elements which operate in parallel and are installed vertically, preferably from the surface configured to allow the separated liquid to return to the catalytic zone or passing through this surface when the device is installed in the recycle zone of a three-phase fluidized reactor, each separation element having an (individual) inlet pipe for admitting the gas-liquid mixture. Preferably, when the gas-liquid separation device is installed in the recycle zone of a three-phase fluidized reactor, each separation element can be open at the (for example conical or hemispherical) surface configured to allow the separated liquid to return (that is to say to be recycled) to the catalytic zone and each separation element rises up to a height H inside the separation zone.

In addition, each separation element comprises a succession of at least two bends positioned (fixed) at the outlet (in the direction of flow of the fluid) of the inlet pipe, a first bend situated in the plane (zy) defined by the substantially vertical z-axis, and a y-axis belonging to the plane (xy) perpendicular to the z-axis, the axis of the first bend being defined by a first angle of orientation α with respect to the vertical z-axis of between 45° and 315°, preferably between 60° and 300°, and preferably between 80° and 200°, and a second bend whose axis forms a second angle of orientation β with the axis of the first bend of between 1° and 135°, preferably between 10° and 110°, and preferably between 30° and 100°, the two first successive bends (therefore the first bend and the second bend) being separated by a distance D1 of between D/2 and 4D, and preferably of between D/2 and 2D, D being the diameter of the inlet pipe. In addition, each separation element comprises a liquid-guiding device, the liquid-guiding device being positioned at the outlet end of the last bend of the succession of at least two bends, the liquid-guiding device being open at the top, all the way along the liquid-guiding device from an inlet section to an outlet section, when the system is on the vertical axis (that is to say when the inlet pipe is vertical) and the outlet section of the liquid-guiding device being positioned vertically below the inlet section of the liquid-guiding device.

### SUMMARY OF THE INVENTION

The invention relates to a gas-liquid separation device comprising a plurality of separation elements which operate in parallel and are installed vertically, each separation element having an inlet pipe for admitting the gas-liquid mixture, and a succession of at least two bends, a first bend situated in the plane (zy) defined by the substantially vertical z-axis, and a y-axis belonging to the plane (xy) perpendicular to the z-axis, the axis of the first bend being defined by a first angle of orientation α with respect to the vertical z-axis of between 45° and 315°, preferably between 60° and 300°, and preferably between 80° and 200°, and a second bend whose axis forms a second angle of orientation β with the axis of the first bend of between 1° and 135°, preferably between 10° and 110°, and preferably between 30° and 100°, the first bend and the second bend being separated by a distance D1 of between D/2 and 4D, and preferably of between D/2 and 2D, D being the diameter of the inlet pipe. In addition, each separation element comprises a liquid-guiding device, the liquid-guiding device being positioned at the outlet end of the last bend of the succession of at least two bends, the liquid-guiding device being open over its entire length, from its inlet section to its outlet section (all the way along the device for distributing the fluid) in the direction of circulation of the fluid in this device for distributing the fluid, and the outlet section of the liquid-guiding device being positioned vertically below the inlet section of the liquid-guiding device.

Preferably, the gas-liquid separation device is configured to be installed in the recycle zone of a three-phase fluidized reactor used in a process for the hydroconversion of heavy hydrocarbon cuts in the presence of hydrogen under high pressure, the recycle zone being made up of the upper hemisphere of the reactor and delimited in its lower part by a surface configured to allow the separated liquid to return to the catalytic zone, and the distance separating the outlet end of the last bend from a gas-liquid interface in the recycle zone is between D and 10D, and preferably between 2D and 5D.

Advantageously, the second bend forms an angle with the plane (zy) of between 1° and 90°, preferably between 1° and 45°, and more preferably between 1° and 20°.

According to one configuration of the invention, the liquid-guiding device comprises at least one deflector and/or at least one slot.

Preferably, the liquid-guiding device (the pipe portion of the liquid-guiding device) is open at an opening angle of between 60° and 179°, preferably between 90° and 150°, and more preferably between 100° and 130°, with respect to the neutral line. In other words, each section of the liquid-guiding device, along the liquid-guiding device from its inlet section to its outlet section, forms an opening angle of between 60° and 179°, preferably between 90° and 150°, and more preferably between 100° and 130°, between the end points of this section (open by definition, the guiding device being open at the top) and the center of the neutral axis of this section.

Advantageously, the vertical height of the liquid-guiding device is between D/2 and 8D, preferably between 2D and 5D.

According to one implementation of the invention, the inlet section of the liquid-guiding device and the outlet section of the liquid-guiding device form an angle of rotation in the plane (x,y), said angle of rotation being between 45° and 200°, preferably between 90° and 180°.

Preferably, the outlet section of the liquid-guiding device has an elliptical profile, an inverted elliptical profile or a flat profile (the outlet section forms a straight-line segment).

The invention also relates to a three-phase fluidized reactor for the hydroconversion of heavy hydrocarbon cuts in the presence of hydrogen under high pressure, the reactor comprising a recycle zone made up of the upper hemisphere of the reactor and delimited in its lower part by a surface configured to allow the separated liquid to return to the catalytic zone, the recycle zone comprising a gas-liquid separation device as described above.

The invention also relates to a process for the three-phase fluidized bed hydroconversion of heavy hydrocarbon cuts using the gas-liquid separation device the invention, wherein the operating conditions are as follows:
an absolute pressure of between 2 MPa and 35 MPa, preferably between 5 MPa and 25 MPa, and more preferably between 6 MPa and 20 MPa, and
a temperature of between 300° C. and 550° C., preferably of between 35° and 500° C., and more preferably of between 370° and 430° C., the favored temperature range lying between 380° C. and 430° C.

Advantageously, the surface velocity of the upflow inside each inlet pipe is between 0.1 m/s and 20 m/s, preferably between 0.2 m/s and 15 m/s, and more preferably between 0.3 m/s and 10 m/s.

Preferably, the volume fraction of liquid in the inlet pipe is between 0.05 and 0.95, preferably between 0.1 and 0.8, and more preferably between 0.3 and 0.6.

Other features and advantages of the separation device, of the reactor and of the process according to the invention will become apparent on reading the description below of non-limiting exemplary embodiments with reference to the appended figures described below.

### LIST OF THE FIGURES

FIG. 1 shows a three-phase fluidized reactor with a gas-liquid separation device according to the prior art.

FIG. 2 shows a gas-liquid separation device in a three-phase fluidized reactor with a succession of two bends according to the prior art.

FIG. 3 shows a gas-liquid separation device with two bends according to the prior art.

FIG. 4 shows a gas-liquid separation device with a liquid-guiding device according to the invention.

FIG. 5 shows a first example of a liquid-guiding device of a separation element of the gas-liquid separation device according to the invention.

FIG. 6 illustrates different variants of the liquid-guiding device of a separation element of the gas-liquid separation device according to the invention.

FIG. 7 shows the inlet section of the liquid-guiding device of a separation element of the gas-liquid separation device according to the invention.

FIG. 8 shows a first example of a semi-elliptical outlet section of the liquid-guiding device of a separation element of the gas-liquid separation device according to the invention.

FIG. 9 shows a second example of an inverted semi-elliptical outlet section of the liquid-guiding device of a separation element of the gas-liquid separation device according to the invention.

FIG. 10 shows a third example of a flat outlet section of the liquid-guiding device of a separation element of the gas-liquid separation device according to the invention.

FIG. 11 shows a comparison of the profiles of the liquid volume fraction at the gas-liquid interface between a gas-liquid separation device ending in two bends according to the prior art a) and a gas-liquid separation device with a liquid-guiding device according to the invention b).

### DESCRIPTION OF THE EMBODIMENTS

The invention relates to a gas-liquid separation device notably for being installed in the recycle zone of the three-phase fluidized reactors used in processes for the hydroconversion of heavy hydrocarbon cuts in the presence of hydrogen under high pressure, said process being known under the name H-Oil™.

The present device can be used in any type of equipment that has need of gas-liquid separation.

The gas-liquid separation device can also be used in other systems where separation between a gas and a liquid is necessary, for example in a separator of the ISS (Internal Stage Separator) type or of the HHPS (Hot and High Pressure Separator) type, these separators being used in processes for the hydroconversion of heavy hydrocarbon cuts.

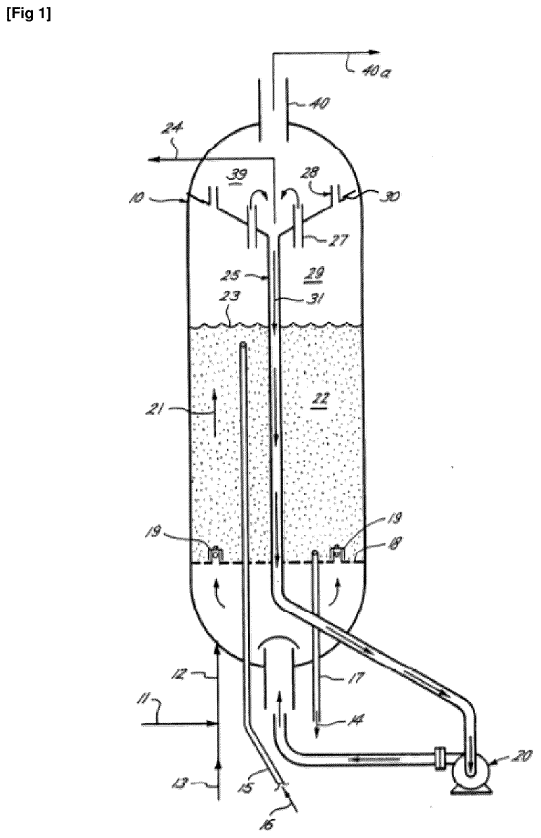

When the device is installed in the recycle zone of a three-phase fluidized reactor, the organization of the circulation of the fluids shown in FIG. 1 is not modified in the present invention with respect to the prior art as described above. The only thing modified is the geometry of the separation elements (27) and (28) in FIG. 1.

The expression “three-phase fluidized bed process” is understood to mean a process in which three phases are present in the reaction zone: a liquid phase, generally constituting the feedstock to be treated; a gas phase under high pressure, generally hydrogen; and a solid phase corresponding to the catalyst divided into solid particles, usually of a diameter of between 0.2 mm and 2 mm, and preferably of between 0.7 mm and 1.5 mm.

The three-phase fluidized reactor in which the gas-liquid separation device can be installed comprises a recycle zone made up of the upper hemisphere of the reactor and delimited in its lower part by a surface configured to allow the separated liquid to return to the catalytic zone, for example via a central outlet duct allowing the separated liquid to be collected. The surface configured to allow the separated liquid to return to the catalytic zone may be conical or hemispherical, for example.

The recycle zone of the three-phase fluidized reactor is thus broken down into an upper part comprising the gas, and into a lower part comprising the liquid. In the reactor in operation, these two zones are separated by a gas-liquid interface.

The gas-liquid separation device comprises a plurality of separation elements which operate in parallel and are installed vertically (preferably from the surface configured to allow the separated liquid to return to the catalytic zone or passing through this surface when the device is installed in the recycle zone of a three-phase fluidized reactor) and each separation element has an inlet pipe for admitting the gas-liquid mixture (preferably open at the surface configured to allow the separated liquid to return to the catalytic zone and rising up to a height H inside the separation zone when the device is installed in the recycle zone of a three-phase fluidized reactor) configured for a downflow of the gas-liquid mixture, and a succession of at least two bends, the successive bends being fixed to one another. The inlet pipe is substantially vertical. The succession of bends is positioned and fixed at the outlet of the inlet pipe in the direction of circulation of the gas-liquid mixture in the separation element. The terms “first”, “second”, “third”, “fourth”, “next”, “previous” or “last”, when they are associated with “bend”, are understood in the direction of circulation of the fluid in the succession of at least two bends. Thus, the first bend will be the one which is passed through first by the fluid, in the direction of circulation of the fluid (gas-liquid mixture). The succession of at least two bends is positioned at the outlet of the inlet pipe so as to force the fluid leaving the inlet pipe to pass through the succession of bends. The passage through the succession of the at least two bends allows effective separation of the liquid and of the gas.

“Concave” surface is understood to mean a surface forming a hollow, that is to say a shape rounded toward the inside. “Convex” surface is understood to mean a curved surface, that is to say rounded toward the outside.

The terms “vertical”, “horizontal”, “upper”, “lower”, “above”, “below”, “top” and “bottom” are understood in relation to the gas-liquid separation device in the operating situation (in the operating situation).

In the present description, the vertical axis is considered to be oriented upward; the angles considered in the present description are therefore given with respect to this upward orientation of the vertical axis.

The first bend is situated in the plane (zy) defined by the substantially vertical z-axis, and a y-axis belonging to the plane (xy) perpendicular to the z-axis. In other words, the plane (zy) is a substantially vertical plane and the plane (xy) is a substantially horizontal plane. The axis of the first bend is defined by a first angle of orientation α with respect to the vertical z-axis (which corresponds substantially to the axis of the inlet pipe) of between 45° and 315°, preferably between 60° and 300°, and preferably between 80° and 200°. The first bend is fixed at the outlet of the inlet pipe.

A second bend is fixed to the first bend (at the end opposite the one fixed to the inlet pipe). In other words, it is in the continuation of the first bend. The axis of the second bend forms a second angle of orientation β with the axis of the first bend. The second angle of orientation is between 1° and 135°, preferably between 10° and 110°, and preferably between 30° and 100°. Preferably, the second bend is in a plane forming a non-zero angle with the plane (zy), for example the second bend may be in the substantially horizontal plane (xy). Thus, the first and second bends are not co-planar. By using these two successive bends (that is to say the first and second bends) in two planes that are secant with one another, the separation of the liquid and of the gas is promoted. In addition, these two successive bends are separated by a distance D1 of between D/2 and 4D, and preferably of between D/2 and 2D, D being the diameter of the inlet pipe.

According to one implementation of the invention, the gas-liquid separation device of the invention may comprise between 10 and 50 separation elements, preferably between 20 and 40 separation elements, in order to improve the capacities for separating the liquid and the gas. The number of separation elements is notably dependent on the flow rate to be treated.

Furthermore, each separation element comprises a liquid-guiding device which may take the form of a chute. The aim of this liquid-guiding device is to convey the liquid gently toward the outlet (the central outlet duct of the three-phase fluidized reactor, for example). The liquid-guiding device is positioned at the outlet end (in the direction of flow of the gas-liquid mixture) of the last bend of the succession of at least two bends. The bends are successively fixed to one another, and the guiding device is fixed to the outlet end of the last bend. For example, if the succession of at least two bends comprises four bends fixed to one another, the liquid-guiding device is fixed to the fourth bend; if the succession of at least two bends comprises two bends fixed to one another, the liquid-guiding device is fixed to the second bend. The liquid-guiding device is open at the top so as to allow the gas to escape upward and to direct the liquid downward. Thus, the open part of the liquid-guiding device (notably of the pipe portion) is positioned on the upper part allowing the gas to escape whilst the lower part of the liquid-guiding device (notably of the pipe portion) guides the liquid.

The liquid-guiding device may be made up of a pipe portion running from the inlet section to the outlet section.

Furthermore, the liquid-guiding device is open (the pipe portion of the liquid-guiding device is open), at the top, so as to distribute the fluid all the way along (over the entire length) of the liquid-guiding device in the direction of circulation of the fluid in this liquid-guiding device from an inlet section to an outlet section. The pipe portion is then open over the entire length of the liquid-guiding device, the length being measured from the inlet section to the outlet section along the neutral axis of the liquid-guiding device. The term “pipe portion” refers to a part in the form of a pipe whose section is open over its entire length.

By virtue of this liquid-guiding device that is open over its entire length, the liquid can be conducted by the section of the device whilst the gas can escape by virtue of the opening at the top. The separation between these two fluids is then facilitated.

Furthermore, the outlet section of the liquid-guiding device is positioned vertically below the inlet section of the liquid-guiding device. Thus, by the effect of gravity applied to the liquid, the guiding device guides the liquid downward in the desired direction. The guiding device simultaneously directs the liquid in the desired direction (toward the outlet duct for recirculation to the pump of the three-phase fluidized reactor, for example), by gently conveying it in this direction, and thus limits the turbulence and the foaming phenomena.

The liquid-guiding device (notably the pipe portion) may notably comprise a direction change, which is preferably continuous and has no slope discontinuity, from the inlet section to the outlet section, in the direction of flow of the fluid in the device.

Preferably, the section of the liquid-guiding device may be constant along the liquid-guiding device (over the entire length of the liquid-guiding device) from the inlet section to the outlet section. As an alternative, the section of the liquid-guiding device may vary continuously and without discontinuity from the inlet section to the outlet section, along the liquid-guiding device (over the entire length of the liquid-guiding device).

Thus, the liquid-guiding device forms a chute from the inlet section to the outlet section. The pipe portion is open at the top, the lower part of the pipe portion conducting the liquid by gravity and the gas being able to escape from the top, by virtue of the opening, at the top of the pipe portion.

Preferably, the distance H1 separating the outlet end of the last bend of the succession of at least two bends from a gas-liquid interface, for example in the recycle zone of a three-phase fluidized reactor, may be between D and 10D, and preferably between 2D and 5D. This makes it possible to effectively separate the gas and the liquid.

Advantageously, the second bend may form an angle with the plane (zy) of between 1° and 90°, preferably between 1° and 45°, and more preferably between 1° and 20°. Thus, the second bend is not in a plane that is co-planar with the plane of the first bend. By using these two successive bends (that is to say the first and second bends) in two planes that are secant with one another forming in particular the angles mentioned above, the separation of the liquid and of the gas is promoted.

Advantageously, the liquid-guiding device may comprise at least one deflector (preferably several deflectors) and/or at least one slot (preferably several slots).

The use of deflectors improves the distribution of the liquid over the section of the guiding device by preventing the liquid from being concentrated in the lowest part. Hence, it is possible to limit the acceleration of the liquid.

The use of slots also reduces the velocity of the liquid so as to convey it gently toward the outlet and improves the distribution of the liquid.

By limiting the velocity of the liquid, it is possible to reduce the movement quantity of the liquid and therefore limit its impact on the gas-liquid interface (turbulence, foaming).

According to an advantageous embodiment of the invention, the liquid-guiding device (notably the pipe portion) may be open at an opening angle of between 60° and 179°, preferably between 90° and 150°, and more preferably between 100° and 130°, with respect to the neutral line (the axis of the pipe portion, for example). This opening angle makes it possible to facilitate the removal of the gas and to have a section that is large enough to effectively guide the liquid.

Preferably, the vertical height of the liquid-guiding device may be between D/2 and 8D, preferably between 2D and 5D. Thus, the outlet section of the liquid-guiding device is above the gas-liquid interface and the height of the liquid-guiding device is enough for the liquid-guiding device to act in a similar manner to a chute for the liquid for guiding it toward the outlet.

Advantageously, the angle of rotation formed between the inlet section of the liquid-guiding device and the outlet section of the liquid-guiding device, in the substantially horizontal plane (xy), may be between 45° and 200°, preferably between 160° and 190°. Thus, it is possible to effectively direct the liquid toward the central outlet duct of the three-phase fluidized reactor.

In addition, the liquid-guiding device comprises a surface that is continuous and has no discontinuity from the inlet section to the outlet section so as to progressively direct the liquid arriving from the inlet section toward the outlet section. The guiding device thus forms a rounded (or curved) profile.

According to one variant of the invention, the outlet section of the liquid-guiding device may be larger than the inlet section of the liquid-guiding device. This section widening therefore makes it possible to increase the contact surface between the liquid and the liquid-guiding device. Thus, it is possible to limit the velocity of the liquid at the outlet of the guiding device. For example, when the inlet section of the liquid-guiding device is semi-circular (or semi-toric) with diameter DD, the outlet section of the liquid-guiding device may be semi-circular with a diameter of between 1.2 DD and 2 DD.

According to advantageous embodiments of the invention, the outlet section of the liquid-guiding device may be concave or convex or flat. When it is concave, it may have a circular (or toric) or elliptical profile. When it is convex, it may have an inverted elliptical or flat profile (that is to say forming a straight-line segment).

The concave sections facilitate the guiding of the liquid by forcing the liquid to be guided to the center of this section. The circular profile is simple to produce. The elliptical profile makes it possible to limit the local concentration of the liquid at the center of the profile by comparison with the circular profile. Thus, the part on which the liquid is carried is widened and thus it is possible to limit the velocity of the liquid and its inertia, notably with regard to its impact on the gas-liquid interface. The concave sections can also effectively distribute the liquid all the way around the guiding device.

The convex sections make it possible to effectively distribute the liquid all the way around the liquid-guiding device. By increasing the distribution zone, concentration of the liquid in a certain zone (the central zone of the concave zones by comparison) is avoided and it is also possible to reduce the velocity of the liquid and its movement quantity. The inverted elliptical profile or the triangular profile notably makes it possible to effectively distribute the liquid over the entire liquid-guiding device.

The flat profile (straight-line segment) enables a simple embodiment while still effectively distributing the liquid.

The invention also relates to a three-phase fluidized reactor for the hydroconversion of heavy hydrocarbon cuts in the presence of hydrogen under high pressure, the reactor comprising a recycle zone made up of the upper hemisphere of the reactor and delimited in its lower part by a surface configured to allow the separated liquid to return to the catalytic zone (for example a conical or hemispherical surface), for example via a central outlet duct for conveying the liquid toward a pump in order to recycle the liquid. In addition, the recycle zone comprises a gas-liquid separation device as described above. The reactor corresponds to the reactor in FIG. 1, as described above, in which only the gas-liquid separation device is modified.

In addition, the invention also relates to a process for the three-phase fluidized bed hydroconversion of heavy hydrocarbon cuts using the gas-liquid separation device as described above (preferably using a three-phase fluidized reactor as described and comprising a gas-liquid separation device according to the invention), wherein the operating conditions are as follows:
an absolute pressure of between 2 MPa and 35 MPa, preferably between 5 MPa and 25 MPa, and more preferably between 6 MPa and 20 MPa, and
a temperature of between 300° C. and 550° C., preferably of between 35° and 500° C., and more preferably of between 370° C. and 430° C., the favored temperature range lying between 380° C. and 430° C.

These pressures and temperatures enable an effective process for the hydroconversion of the heavy hydrocarbon cuts in the presence of hydrogen.

Advantageously, the surface velocity of the upflow inside each inlet pipe may be between 0.1 m/s and 20 m/s, preferably between 0.2 m/s and 15 m/s, and more preferably between 0.3 m/s and 10 m/s.

Preferably, the volume fraction of liquid in the inlet pipe may be between 0.05 and 0.95, preferably between 0.1 and 0.8, and more preferably between 0.3 and 0.6. Thus, the system is suitable for a wide range of liquid volume fractions, the liquid volume fraction representing the liquid volume with respect to the total volume of gas-liquid mixture arriving in the inlet pipe.

FIG. 4 schematically and non-limitingly illustrates a gas-liquid separation device according to the invention.

In the figure on the left, it is possible to see a gas-liquid separation element comprising an inlet pipe 70 and a succession of two bends 71 and 72 (but the succession of bends could comprise more than two bends). The liquid-guiding device is not shown in order to facilitate understanding on the part of the reader.

In the figure on the right, it is possible to see the gas-liquid separation element complete with the liquid-guiding device 73.

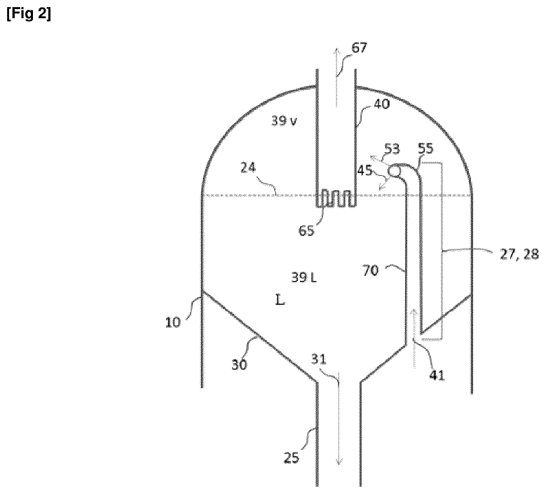

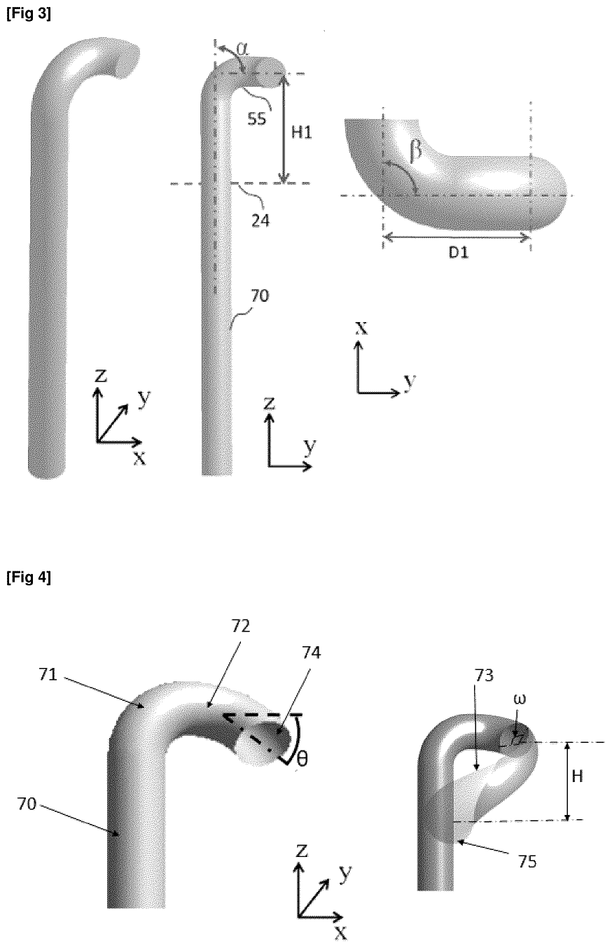

The gas-liquid separation elements in FIG. 4 may replace the separation elements 27 and 28 in FIGS. 1 and 2, such that the gas-liquid separation device comprises several gas-liquid separation elements.

Each separation element comprises an inlet pipe 70 followed by a succession of two bends 71 and 72:
the first bend 71 is positioned in a plane denoted (yz), perpendicular to the horizontal x-axis, the z-axis corresponding substantially to the vertical axis,
the second bend 72 is positioned in a plane forming a non-zero angle with the plane (yz) of the first bend 71. The axis of the second bend forms an angle θ with the horizontal plane (xy). For example, the second bend 72 may be situated in the substantially horizontal plane denoted (xy) and perpendicular to the z-axis: in this case, the angle θ is zero.

Thus, the two bends 71 and 72 are in two non-co-planar planes, these two planes being secant with one another.

Here, the succession of bends is composed of two bends, but the succession of bends may comprise a number of bends greater than 2.

At the outlet 74 of the second bend 72 (in the direction of circulation of the liquid in the gas-liquid separation element), the gas-liquid separation element comprises a liquid-guiding device 73 in which the gas separated from the liquid can be removed from the top, the liquid-guiding device 73 comprising an open section allowing the gas to escape upward (for example toward the upper part of the reactor).

The opening of the pipe portion of the liquid-guiding device 73 makes it possible to convey the liquid in the desired direction, the surface of the liquid-guiding device 73 serving to guide the liquid. For example, the liquid-guiding device 73 may be configured such that the liquid is directed toward the central outlet duct of the recycle cup of the reactor, as shown by the reference 25 in FIG. 1.

The inlet section of the liquid-guiding device 73 (the section fixed at the outlet 74 of the second and last bend) is positioned vertically above the outlet section of the liquid-guiding device 73. The difference in height between the axis of the inlet section and the outlet section of the liquid-guiding device 73 corresponds to the height H. This makes it possible to guide the liquid under the effect of its own gravity.

In addition, the liquid-guiding device 73 may preferably be a 3D (three-dimensional) element, that is to say extending in the three axes x, y and z of an orthonormal frame of reference, it is not situated in one plane (that is to say that it is not 2D (two-dimensional)) and comprises a direction change, this being in order to promote the guiding of liquid toward the outlet. This direction change is preferably continuous and without slope discontinuity in order to progressively guide the liquid. In other words, the surface of the liquid-guiding device forms a continuous direction change without slope discontinuity.

The liquid-guiding device 73 is open at an opening angle ω measured with respect to the axis of the inlet section (corresponding to the neutral line or to the neutral axis of the inlet section). The inlet section of the liquid-guiding device 73 is semi-circular because it is connected to the circular outlet section 74 of the second and last bend 72. It is referred to as “semi-circular” because it is open.

The outlet section 75 of the liquid-guiding device 73 is also semi-circular but other shapes are possible. The outlet section 75 of the liquid-guiding device 73 is larger than its inlet section:

here the diameter of the outlet section 75 is larger than that of the inlet section. By widening the section of the liquid-guiding device, in the direction of flow of the fluid, it is possible to slow said fluid down and to increase the surface on which it slides, this reducing the inertia of the liquid and thus reducing its impact at the gas-liquid interface.

Thus, the liquid-guiding device 73 forms a chute for the liquid.

The liquid flowing after leaving the liquid-guiding device 73 arrives, for example, here, along the conical wall of the three-phase fluidized reactor and is collected by the central outlet duct. The gas is removed via the outlet of the second and last bend via the open part of the liquid-guiding device 73. The gas therefore occupies the upper end of the separation zone situated above the gas-liquid interface and may, for example, leave the reactor via the outlet pipe (the pipe 40 in FIGS. 1 and 2, for example).

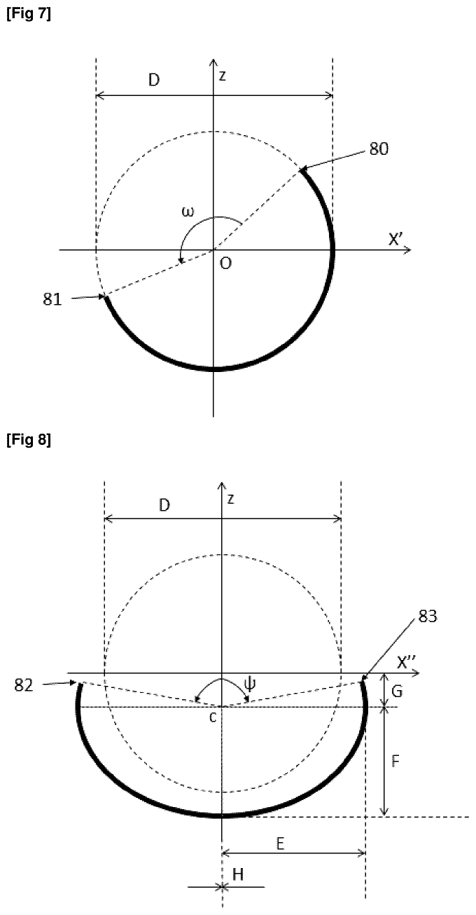

FIG. 7 schematically and non-limitingly illustrates the inlet section of the liquid-guiding device.

The inlet section of the guiding device is semi-circular with diameter D, equal to the diameter of the last bend, and shown by the continuous black line in the figure. It is open at an opening angle ω measured with respect to the axis of the inlet section (axis shown by the point O corresponding to the center of the circle with the diameter D and corresponding to the neutral line or to the neutral axis of the inlet section) between the ends 80 and 81 of the inlet section.

In this figure, the z-axis corresponds to the vertical axis. It can be seen that the ends 80 and 81 are not symmetrical with respect to the vertical z-axis. This asymmetry enables more effective guiding of the liquid in spite of the centrifugal forces to which the liquid is subjected in the direction change of the liquid-guiding device via the angle of rotation.

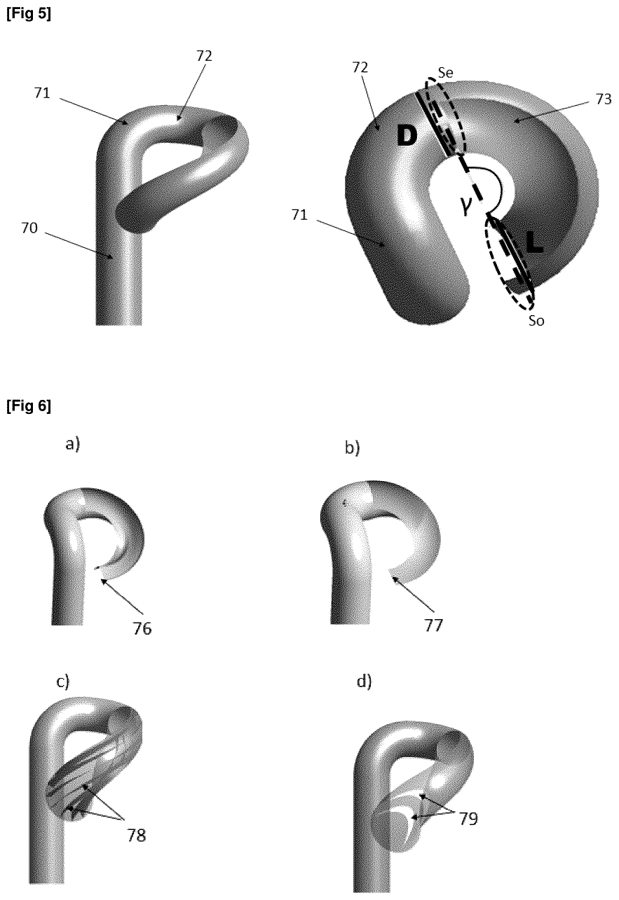

FIG. 5 schematically and non-limitingly illustrates a 3D view of a gas-liquid separation element according to the invention (diagram on the left) and of a top view of the same gas-liquid separation element (diagram on the right).

The gas-liquid separation element comprises an inlet pipe 70 followed by a succession of two bends 71 and 72 (but the succession of bends may comprise more than two bends) in two planes that are secant with one another, the two planes preferably being perpendicular to one another. A liquid-guiding device 73 is fixed at the outlet of the second and last bend 72 and has an open part (open pipe portion).

The inlet pipe 70 and the two bends 71 and 72 are of circular section with diameter D. The semi-circular inlet section Se of the liquid-guiding device 73 also has a diameter equal to D. The outlet section So of the liquid-guiding device 73 is also semi-circular and has a diameter L greater than or equal to the diameter D of the inlet section.

Moreover, the liquid-guiding device 73 follows a rotation from its inlet section Se to its outlet section So. The angle formed between the inlet section Se and the outlet section So is shown by the angle of rotation Y of between 45° and 200°, preferably between 90° and 180°.

FIG. 6 schematically and non-limitingly illustrates different profiles of the outlet section of the liquid-guiding device of gas-liquid separation elements.

In this figure, the gas-liquid separation elements may notably be installed in place of the gas-liquid separation elements 27 and 28 in FIGS. 1 and 2.

The diagrams a) to d) differ only by way of the liquid-guiding device.

In diagram a), the profile of the outlet section is substantially semi-triangular 76 with the apex of the triangle directed upward. “Substantially semi-triangular” is understood to mean that the apex of the triangle may have a curvature and that the third side of the triangle does not form part of the profile: in other words, this semi-triangular profile is in the shape of an inverted V. Thus, the liquid is split into two directed flows of the two sides with respect to the apex of the triangle. Preferably, the triangle is isosceles with respect to the apex or equilateral so as to generate two flows with similar flow rates.

In diagram b), the profile of the outlet section is flat 77 (or linear). In other words, it is formed by a straight-line segment. Thus, the liquid may flow over the entire surface without generating a concentration zone and it is distributed all the way around the outlet section. The inertia of the liquid is therefore distributed.

In diagrams c) and d), the profile of the outlet section is semi-circular.

In diagram c), the liquid-guiding device comprises deflectors 78 which divide the liquid-guiding device into several compartments thus making it possible to prevent the liquid from being concentrated into a single zone (the central zone, for example). To do this, the deflectors 78 preferably extend from the inlet section to the outlet section of the liquid-guiding device and follow the variation of the section profile. The deflectors may be used regardless of the profile of the outlet section.

In diagram d), the liquid-guiding device comprises slots (or openings) allowing the liquid to escape upward. Thus, it is possible to progressively distribute the liquid downward. The slots may be used regardless of the profile of the outlet section.

The variation of the section of the guiding device, from the semi-circular inlet section to the outlet section, regardless of its profile, is progressive, continuous and without slope discontinuity.

The combination of deflectors and slots is also possible, regardless of the profile of the outlet section.

FIG. 8 schematically and non-limitingly illustrates a first example of a concave outlet profile of the liquid-guiding device.

The outlet section of the guiding device is semi-elliptical and shown by the continuous black line in the figure. The circle with diameter D shown by the dashed lines shows the outlet section of the last bend (from which the inlet section of the liquid-guiding device starts), projected onto the plane of the outlet section. The z-axis represents the vertical axis and the x″-axis a horizontal axis.

By virtue of this figure, it can be seen that the outlet section of the liquid-guiding device is larger than the inlet section.

In addition, the elliptical profile of the outlet section is defined by an ellipse with center c, with semi-major axis along the axis X″ of length E and with semi-minor axis along the z-axis of length F. The axes X″ and z are defined by the circular profile of the outlet of the bend with diameter D. The elliptical profile is open with an opening defined by the angle w. The center c of the ellipse is distant from the X″-axis by a length G and from the z-axis by a length H, H being zero in the figure.
The length E is between D/4 and 5D, and preferably between D/2 and 3D.
The length F is between D/4 and 5D, and preferably between D/2 and 3D.
The angle ω is between 10° and 350°, and preferably between 90° and 180°.
The length G is between 0.1F and F, and preferably between 0 and F/2.
The length H is between −E and E, and preferably between −E/2 and E/2.

In this figure, it can be seen that the ends 82 and 83 of the outlet section are symmetrical with respect to the vertical z-axis. This symmetry on the outlet section makes it possible to distribute the liquid effectively, but this symmetry is not obligatory.

The elliptical profile has the advantage, with respect to the circular profile, of increasing the surface on which the liquid is carried. Thus, it is possible to reduce the velocity of the liquid and thus to limit its movement quantity.

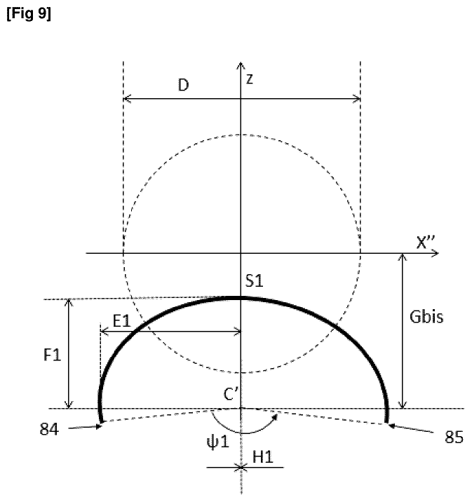

FIG. 9 schematically and non-limitingly illustrates a second example of a convex outlet profile of the liquid-guiding device.

The outlet section of the guiding device is of inverted semi-elliptical form (with respect to FIG. 8) and shown by the continuous black line in the figure. The circle with diameter D shown by the dashed lines shows the outlet section of the last bend (from which the inlet section of the liquid-guiding device starts), projected onto the plane of the outlet section. The z-axis represents the vertical axis and the X″-axis a horizontal axis.

By virtue of this figure, it can be seen that the outlet section of the liquid-guiding device is larger than the inlet section.

In addition, the inverted elliptical profile of the outlet section of the liquid-guiding device is defined by an inverted ellipse with center C′, with semi-major axis along the X″-axis of length E1 and with semi-minor axis along the z-axis of length F1. The axes X″ and z are defined by the circular profile of the outlet of the last bend with diameter D. The elliptical profile is open with an opening defined by the angle ψ1. The center C′ of the ellipse is distant from the X″ axis by a length Gbis and from the z-axis by a length H1, the length H1 being zero in the diagram.
The length E1 is between D/4 and 5D, and preferably between D/2 and 3D.
The length F1 is between D/4 and 5D, and preferably between D/2 and 3D.
The angle ψ1 is between 10° and 350°, and preferably between 90° and 180°.
The length Gbis is between 1.1F and 2F, and preferably between F and 1.5F.
The length H1 is between −E and E, and preferably between −E/2 and E/2.

The advantage of this profile is quite similar to that of the triangular profile of diagram a) in FIG. 6: it makes it possible to split the flow of liquid in two, on either side of the apex of the ellipse S1, the apex of the ellipse S1 being the vertically topmost point of the inverted semi-elliptical section.

In this figure, it can be seen that the ends 84 and 85 of the outlet section are symmetrical with respect to the vertical z-axis. This symmetry on the outlet section makes it possible to distribute the liquid effectively, but this symmetry is not obligatory.

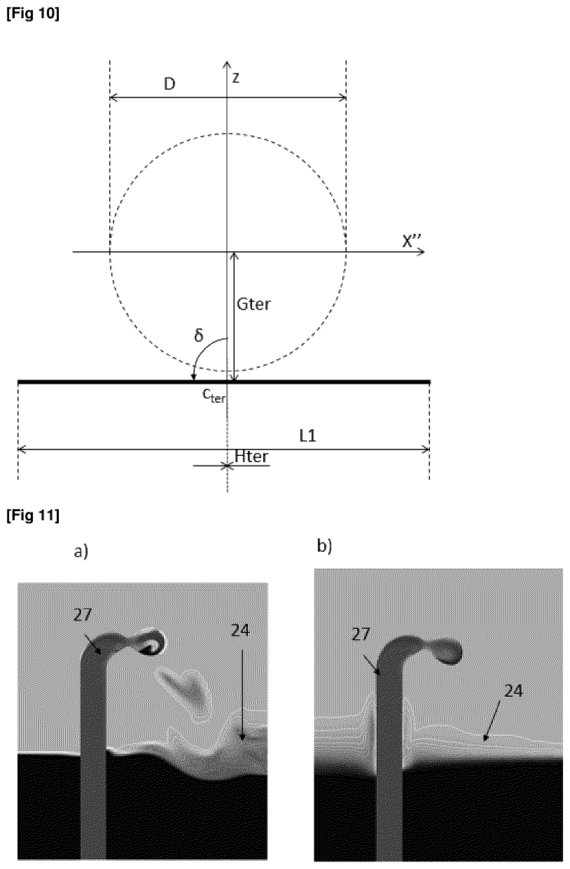

FIG. 10 schematically and non-limitingly illustrates a third example of an outlet profile of the liquid-guiding device.

The outlet section of the guiding device is flat (or linear) forming a straight-line segment, and shown by the continuous black line in the figure. The outlet section is formed by a straight-line segment of length L1. The circle with diameter D shown by the dashed lines shows the outlet section of the last bend (from which the inlet section of the liquid-guiding device starts), projected onto the plane of the outlet section. The z-axis represents the vertical axis and the X″-axis a horizontal axis.

By virtue of this figure, it can be seen that the outlet section of the liquid-guiding device is larger than the inlet section, the length L1 being greater than D.

In addition, the flat profile, forming a straight-line segment, of the outlet section of the liquid-guiding device is defined by the segment of center cter and of length L1. The center cter (corresponding to the middle of the segment of length L1) is at a length Gter from the X″-axis and Hter from the z-axis, the length Hter being zero in the diagram. The segment of length L1 forms an angle δ with the vertical axe.
The length L1 is between D/4 and 5D, and preferably between D/2 and 3D.
The length Gter is between 0.1D and 4D, and preferably between D and 2D.
The length Hter is between −2D and 2D, and preferably between −D and D.
The angle δ is between 60° and 120°, preferably between 80° and 100°.

This profile effectively distributes the liquid and avoids liquid concentration zones.

In this figure, it can be seen that the segment of length L1 is orthogonal to the vertical axis (angle δ equal to) 90° and that the center cter is situated on the vertical axis. Thus the segment of length L1 is symmetrical with respect to the vertical z-axis.

### Examples

FIG. 11 is an example of comparison of the impact of the liquid leaving the gas-liquid separation element 27 of a system according to prior art application US 2019/270941 and of a gas-liquid separation element 27 with a liquid-guiding device of the chute type according to the invention.

The diagrams a) and b) illustrate the level of turbulence generated by the impact of the liquid on the surface of the gas-liquid interface 24. These diagrams are derived by CFD (Computational Fluid Dynamics) numerical simulations. Diagram a) corresponds to the prior art of application US 2019/270941 and diagram b) corresponds to the configuration of FIG. 4 according to the invention.

The variation in levels of gray showing the liquid volume fraction, which is zero for the clearest gray level (pure gas) and shown in black when the fluid is totally liquid.

The table [Table 1] gives the geometric parameters used for the numerical simulations.

TABLE 1

| | Prior art | Configuration of |
|---|---|---|
| | according to | FIG. 4 according |
| Parameter | US 2019/270941 | to the invention |
| Pipe diameter D (m) | 0.14 | 0.14 |
| Angle of the 1^{st} bend with respect | 90° | 90° |
| to the vertical axis (°) | | |
| Angle of the 2^{nd} bend with respect | 90° | 90° |
| to the axis of the first bend (°) | | |
| Angle of the 2^{nd} bend with the | 0° | 15° |
| horizontal axis (°) | | |
| Opening angle of the liquid- | — | 120° |
| guiding device (°) | | |
| Height of the liquid-guiding device | — | 2.15 D |
| Diameter of the outlet section of | | 1.5 D |
| the liquid-guiding device | | |
| Angle of rotation of the liquid- | | 180° |
| guiding device | | |

For these simulations, the gas-liquid interface is positioned 0.6 m from the axis of the outlet section of the liquid-guiding device.

The following data are used for the numerical models:
the model is of the Euler-Euler type with a continuous liquid and a gas dispersed with bubble diameters set equal to 1 mm;
the gas-liquid interaction follows a Schiller-Naumann drag law;
the turbulence follows a realizable k-& model.
the liquid has a bulk density of 738.6 kg/m3 and a viscosity of 0.48 cP (cP corresponding to the unit centipoise; 1 cP=0.001 Pa·s);
the gas has a bulk density of 50.89 kg/m3 and a viscosity of 0.024 cP (cP corresponding to the unit centipoise; 1 cP=0.001 Pa·s);
the flow rate at the inlet of the separation element is 7.886 kg/s for the liquid and 0.394 kg/s for the gas.

In the prior art diagram a), it is possible to see the creation of a significant wave (shown by the variations in gray in the diagram which evidences a gas-liquid mixture in this zone) at the gas-liquid interface 24. It therefore gives rise to significant turbulence at the gas-liquid interface 24 due to the impact of liquid. This turbulence may be the source of foaming.

In diagram b) of the invention, it is possible to see that the gas-liquid interface 24 (variation in gray) is not disrupted. The level of turbulence is therefore reduced considerably by virtue of the device of the invention. Consequently, it is also possible to reduce the risk of foaming.

Thus, the invention therefore makes it possible to limit the turbulence and the risks of foaming at the gas-liquid interface.

1. A gas-liquid separation device comprising a plurality of separation elements (27) and (28) which operate in parallel and are installed vertically, each separation element (27, 28) having an inlet pipe (70) for admitting the gas-liquid mixture, and a succession of at least two bends (71, 72), a first bend (71) situated in the plane (zy) defined by the substantially vertical z-axis, and a y-axis belonging to the plane (xy) perpendicular to the z-axis, the axis of the first bend (71) being defined by a first angle of orientation α with respect to the vertical z-axis of between 45° and 315°, preferably between 60° and 300°, and preferably between 80° and 200°, and a second bend (72) whose axis forms a second angle of orientation β with the axis of the first bend (71) of between 1° and 135°, preferably between 10° and 110°, and preferably between 30° and 100°, the first bend (71) and the second bend (72) being separated by a distance D1 of between D/2 and 4D, and preferably of between D/2 and 2D, D being the diameter of the inlet pipe (70), characterized in that each separation element (27, 28) comprises a liquid-guiding device (73), the liquid-guiding device (73) being positioned at the outlet end of the last bend of the succession of at least two bends, the liquid-guiding device (73) being open, all the way along the liquid-guiding device in the direction of circulation of the fluid in this liquid-guiding device from an inlet section (Se) to an outlet section (So), and the outlet section (So) of the liquid-guiding device (73) being positioned vertically below the inlet section (Se) of the liquid-guiding device (73).

2. The device as claimed in claim 1, wherein the second bend (72) forms an angle with the plane (zy) of between 1° and 90°, preferably between 1° and 45°, and more preferably between 1° and 20°.

3. The device as claimed in claim 1, wherein the liquid-guiding device (73) comprises at least one deflector (78) and/or at least one slot (79).

4. The device as claimed in claim 1, wherein the liquid-guiding device (73) is open at an opening angle (ω) of between 60° and 179°, preferably between 90° and 150°, and more preferably between 100° and 130°, with respect to the neutral line of the liquid-guiding device.

5. The device as claimed in claim 1, wherein the vertical height (H) of the liquid-guiding device (73) is between D/2 and 8D, preferably between 2D and 5D.

6. The device as claimed in claim 1, wherein the inlet section (Se) of the liquid-guiding device (73) and the outlet section (So) of the liquid-guiding device (73) form an angle of rotation (Y), in the plane (x,y), said angle of rotation (Y) being between 45° and 200°, preferably between 90° and 180°.

7. The device as claimed in claim 1, wherein the outlet section (So) of the liquid-guiding device (73) has an elliptical profile, or a flat profile forming a straight-line segment.

8. A three-phase fluidized reactor for the hydroconversion of heavy hydrocarbon cuts in the presence of hydrogen under high pressure, the reactor comprising a recycle zone (39) made up of the upper hemisphere of the reactor and delimited in its lower part by a surface configured to allow the separated liquid to return to the catalytic zone, the recycle zone (39) comprising a gas-liquid separation device as claimed in claim 1.

9. A process for the three-phase fluidized bed hydroconversion of heavy hydrocarbon cuts using the gas-liquid separation device as claimed in claim 1, wherein the operating conditions are as follows:
an absolute pressure of between 2 MPa and 35 MPa, preferably between 5 MPa and 25 MPa, and more preferably between 6 MPa and 20 MPa, and
a temperature of between 300° C. and 550° C., preferably of between 35° and 500° C., and more preferably of between 370° and 430° C., the favored temperature range lying between 380° C. and 430° C.

10. The process for the three-phase fluidized bed hydroconversion of heavy hydrocarbon cuts as claimed in claim 10, wherein the surface velocity of the upflow considered inside each inlet pipe (70) is between 0.1 m/s and 20 m/s, preferably between 0.2 m/s and 15 m/s, and more preferably between 0.3 m/s and 10 m/s.

11. The process for the three-phase fluidized bed hydroconversion of heavy hydrocarbon cuts as claimed in claim 10, wherein the volume fraction of liquid in the inlet pipe is between 0.05 and 0.95, preferably between 0.1 and 0.8, and more preferably between 0.3 and 0.6.
